(19) United States
(12) Patent Application Publication
(10) Pub. No.: US 2019/0003837 A1
(43) Pub. Date: Jan. 3, 2019

(54) NAUTICAL VEHICLE MONITORING SYSTEMS

(71) Applicant: SeaDogg Inc., Los Altos, CA (US)

(72) Inventors: Burkhard Joachim Huhnke, Los Altos, CA (US); Justus Konstantin Huhnke, Los Altos, CA (US); Felix Jonathan Huhnke, Los Altos, CA (US); Marius Johannes Huhnke, Los Altos, CA (US)

(21) Appl. No.: 15/639,241

(22) Filed: Jun. 30, 2017

(51) Int. Cl. G01C 21/20; G06Q 40/08; H04W 4/02

(52) U.S. Cl. CPC G01C 21/203; H04W 4/02; G06Q 40/08

(57) ABSTRACT

Nautical vehicle monitoring systems are disclosed herein. An example system includes a server configured to store journey data, and a plurality of sensors including a plurality of cameras that are configured to mount on a nautical vehicle, a location sensor that locates a position of the nautical vehicle, a sensor that measures velocity or acceleration of the nautical vehicle, an environmental condition sensor that measures any of wind speed and direction, temperature, air pressure, and combinations thereof, and the server is configured to transmit travel zone information to a mobile device located in proximity to the nautical vehicle based on the journey data.

### FIELD OF THE PRESENT DISCLOSURE

The present disclosure relates generally to nautical vehicle technology, and more particularly, but not by limitation, to systems and methods that provide nautical vehicle monitoring through a plurality of sensors mounted on a nautical vehicle. In some embodiments, the sensors collect journey data during operation of the nautical vehicle and execute remediating measures based on nautical vehicle location or events such as collisions.

### SUMMARY

Various embodiments of the present disclosure are directed to a system, comprising: (a) a server configured to store journey data; and (b) a plurality of sensors comprising: (i) a plurality of cameras that are configured to mount on a nautical vehicle; (ii) a location sensor that locates a position of the nautical vehicle; (iii) a sensor that measures velocity or acceleration of the nautical vehicle; (iv) an environmental condition sensor that measures any of wind speed and direction, temperature, air pressure, and combinations thereof; (c) wherein the journey data comprises a collection of information obtained from the plurality of sensors; and (d) wherein the server is configured to transmit travel zone information to a mobile device located in proximity to the nautical vehicle based on the journey data.

Various embodiments of the present disclosure are directed to a method, comprising: (a) receiving journey data from a plurality of sensors located on a nautical vehicle, wherein the journey data comprises: (1) images obtained from a plurality of cameras on the nautical vehicle; (2) location information of the nautical vehicle; (3) velocity or acceleration of the nautical vehicle; (4) environmental conditions that comprise any of wind speed and direction, temperature, air pressure, and combinations thereof; and (5) audio information obtained from a microphone on the nautical vehicle; (b) transmitting travel zone information to a mobile device, the travel zone information comprising information that is indicative of operating zones near the nautical vehicle; and (c) processing the journey data to create a journey report that illustrates or describes the journey data of the nautical vehicle obtained during use.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art, having the benefit of the description herein.

FIG. 1 is a perspective view of an example system that can be used to practice aspects of the present disclosure.

FIG. 2 is a schematic diagram of an example nautical vehicle configured in accordance with the present disclosure.

FIG. 3 is a flow diagram of an example methodology of the present technology that includes various modes of operation of systems disclosed herein.

FIG. 4 is a perspective view of an operating area with virtual geofence areas corresponding to travel zones.

FIG. 5 is a schematic diagram of an example computer system that can be used to practice aspects of the present disclosure.

### DESCRIPTION OF EXEMPLARY EMBODIMENTS

According to some embodiments, the present disclosure is generally directed to server based systems that collect various sensor data from boats, such as position, speed, hull top view or damage and/or collision information, and other similar data. The server can collect this data through an acquisition device on the nautical vehicle. An example acquisition device would include a mobile device associated with an individual on the nautical vehicle such as a boat operator or captain.

The server can transmit to the mobile device virtual geofence information about local travel zones, synchronize tagged info with geo data, and create a journey report and inspection protocol including user rating review to be shared on an Internet portal or with insurance companies.

In more detail, the present disclosure describes a server based system, which is configured for collecting vessel information, such as position, speed, event data comprised of photos, video or audio recording, boat specific diagnostic information, weather data, marine life density information or collision information (e.g., pictures or videos) including top view hull cameras via a smartphone or mobile device.

Having more than one probe online, the swarm information can be shared via an Internet portal with other users or third parties. In some embodiments, the server provides geofence information to the mobile device including local travel zones such as no wake, speed limit, restricted areas (proximity to the beach) or zones with higher damage probability. The server delivers position based instructions and instructions to boat users traveling in or changing travel zones. The user can tag information like video, sound, photo and so forth that can be embedded or otherwise synchronized with the current boat position. In case of a collision or other event of interest, photo documentation can be sent to the server based on information collected from any of a collision detection sensor, a solid borne sensor or microphone alternatively and the top view hull cameras, and so forth. The collision information will be provided automatically to the server and the server can create, at the end of the journey, any of a travel report, including tagged events synchronized with the position which can be shared via the data center on an Internet portal automatically and/or an operation report about the user behavior in local travel zones. The report can be used as inspection protocol at the end of the use and as a user rating review (such as safest coxswain which will be shared) with a boat owner or insurance company.

These systems and methods are advantageous in scenarios where a boat operator may be renting or leasing a boat from a boat owner. These rental or lease boat operators may have little or no experience operating a boat. Moreover, while operating instruction may be provided by the boat owner prior to use, there is no guarantee that the boat operator will operate the boat in accordance with all appropriate regulations.

The present disclosure provides the ability to record nautical vehicle operating data (e.g., journey data) during use, which will reduce or eliminate disputes between the boat operator and boat owner if or when an operating infraction or collision occurs.

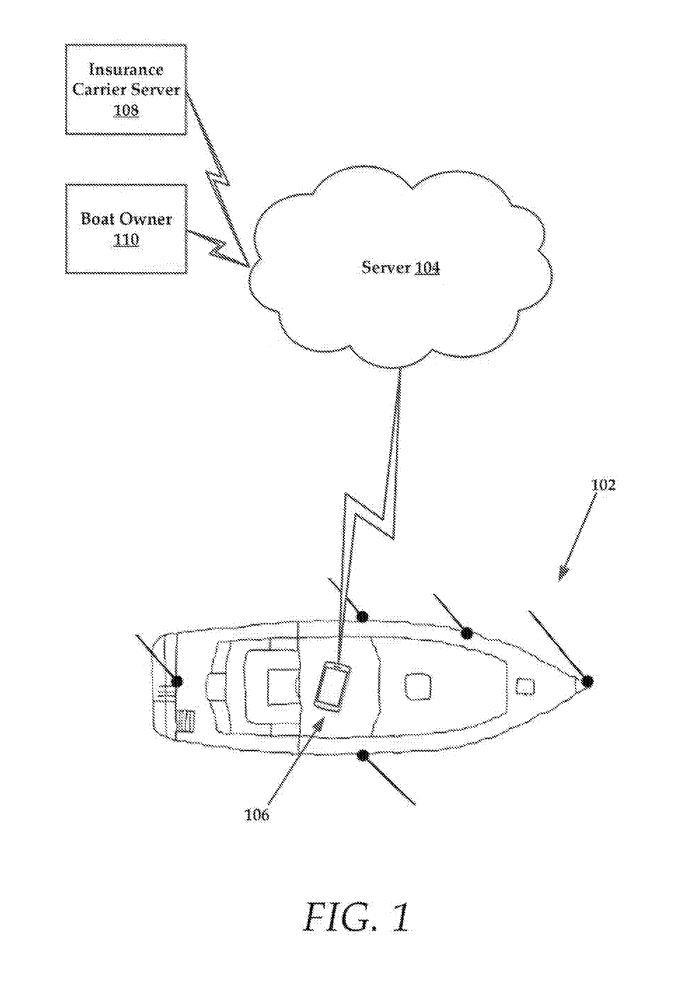

FIG. 1 is a schematic diagram of an example system 100 constructed in accordance with the present disclosure. The system 100 generally comprises a nautical vehicle, such as a boat 102 and a server 104. A mobile device 106 can be used to collect journey data from the boat 102 (directly or indirectly through sensors mounted on the boat 102) and transmit journey data to the server 104. In some embodiments, the server 104 can transmit information to the mobile device 106 such as travel zone information and so forth. Reports and other journey data and/or boat data can be transmitted to an insurance carrier server 108 and/or a boat owner 110 as needed.

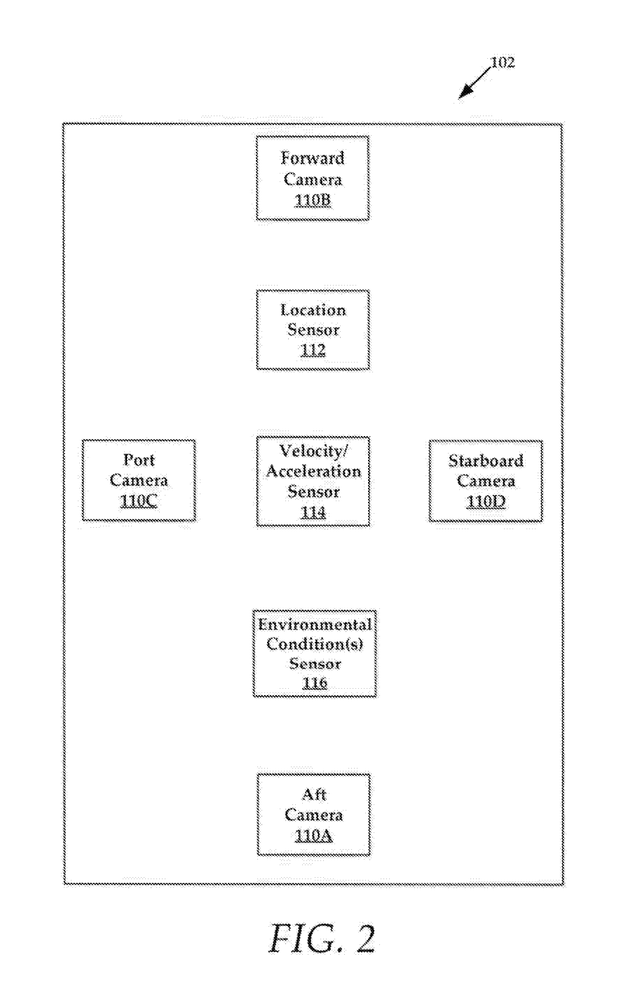

Referring now to FIG. 2, an example schematic diagram of the boat 102 is illustrated. The boat 102 comprises a plurality of sensors that are used to capture boat operational data, which can be collected into journey data.

In some embodiments, the sensors comprise a plurality of cameras that are configured to mount on the boat 102. For example, an aft camera 110A, a forward camera 110B, a port camera 110C, and a starboard camera 110D can be implemented. In some embodiments, an additional camera can be disposed on a highest point of the boat 102 such as a mast or radar antenna. Additional or fewer cameras than those illustrated can be used as well.

The boat 102 can also comprise a location sensor 112 that locates a position of the boat 102. In some embodiments, the location sensing capabilities of the mobile device can be leveraged in addition to or in place of the location sensor 112.

In one or more embodiments, the boat 102 can comprise a sensor 114 that measures velocity or acceleration of the boat 102. According to some embodiments, the boat 102 can comprise an environmental condition(s) sensor 116 that measures any of wind speed and direction, temperature, air pressure, and combinations thereof.

Each of these individual sensors can be configured to transmit their respective data to the mobile device onboard using, for example, short range wireless communications such as Bluetooth or near field communications. In another embodiment, the boat 102 can comprise, for example, a wireless hub that communicatively couples the mobile device and the plurality of sensors on the boat 102. Each of the sensors transmits its data to the hub, then the hub forwards the data to the mobile device.

In general, the data collected by the sensors and/or the mobile device is collectively referred to as journey data. That is, the journey data comprises a collection of information obtained from the plurality of sensors.

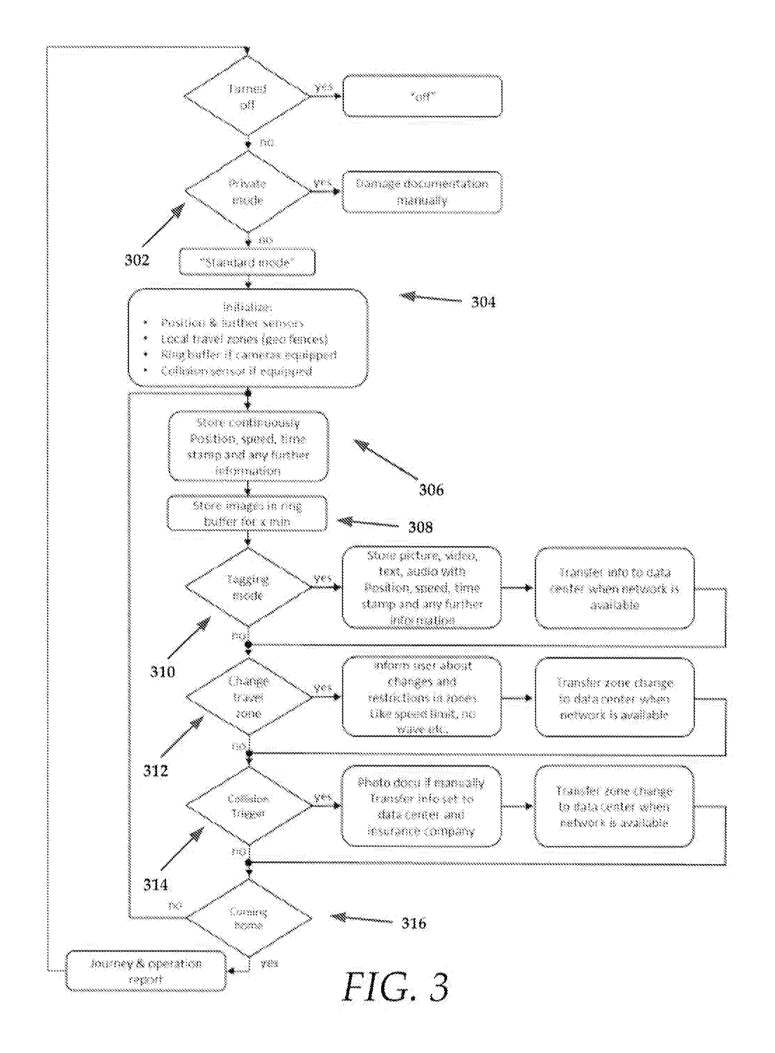

FIG. 3 is a flow diagram of an example method that can be executed using the systems of FIGS. 1 and 2. The method can be separated generally into three operating modes. The operating modes can include, for example, a private mode, a standard mode, and an event mode. When the system is functioning in the private mode as in step 302, the boat operator (user associated with the mobile device) is required to record boat operating information and/or journey data manually, even in the event that a collision or other event has occurred.

When operating in standard mode as initiated in step 304, the system executes an initiation procedure where all sensors on the boat are activated. Any virtual geofences established by the server are initiated and transmitted to the mobile device. In some embodiments, a ring buffer is established on the mobile device. This includes a space in available memory on the mobile device that is used to store journey data when the mobile device is outside cellular communications range, such as when the mobile device has no cellular service. This allows journey data to be obtained by the mobile device from the sensors for asynchronous transfer to the server when the mobile device is in range of the cellular service again. Synchronous transfer can occur any time when the mobile device can communicate with the server.

Thus, according to some embodiments, the method includes a step 306 of continuously storing journey data such as images, position, speed, time stamps, wind speed, temperature, and any other journey data available from the sensors mounted on the boat or sensed directly by the mobile device.

In some embodiments, the method includes a step 308 of storing images in the ring buffer for a specified period of time. This time could be pre-defined, such as an hour, or could be defined as the time during which the mobile device is unable to communicate with the server.

The method can include a tagging mode in step 310 where media such as images, video, audio, text, or other information obtained from one or more of the cameras mounted on the boat are tagged with descriptive information that includes journey data that is currently being collected. A time stamp is applied to the journey data to ensure that the journey data can be tied to a specific time which allows correlation to an event.

Step 312 allows for automatic changes to a current travel zone for the boat. For example, if the boat is operating in a no wake travel zone, but based on current speed and direction the server determines that the boat is about to cross into an open area, the server will transmit to the mobile device instructions that cause the mobile device to display messages to the boat operator that the boat is approaching an open zone. It will be understood that similar messages can be displayed to the boat operator when they are in a specific travel zone and/or are about to enter a different travel zone.

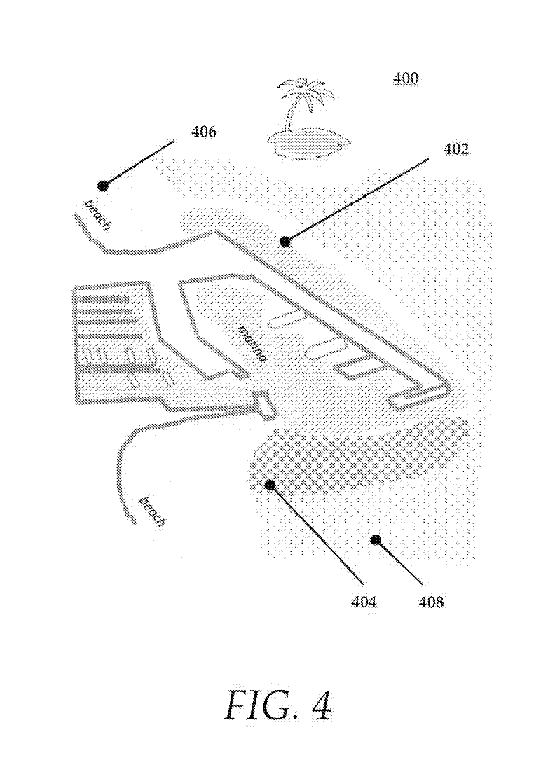

Again, these position related features are available when the mobile device continuously (or in some instances asynchronously) transmits position data to the server and the server compares the current and/or future anticipated position of the boat to virtual geofence areas established or maintained by the server. An example illustration of virtual geofence areas are illustrated in FIG. 4, which will be described in greater detail below.

In step 314 the method includes activating a collision trigger. This can occur automatically when the server and/or mobile device detect that a collision event has likely occurred. In one embodiment, a collision event can be assumed or inferred when an acceleration of the boat changes rapidly and/or abruptly. In these instances, the server (and/or the mobile device) can determine such information from an accelerometer that outputs acceleration data. If a collision event is determined or inferred, the server can cause the mobile device to obtain images from all active cameras. The user can also utilize the mobile device to obtain images manually using a camera on the mobile device. This information can be transmitted to the server and/or an insurance carrier server.

Step 316 includes a homeward mode where journey and/or operation reports are generated and transmitted to a boat owner and/or an insurance carrier sever (when a collision or other loss event has occurred).

FIG. 4 illustrates a perspective view of an operating area having various virtual geofence areas that are specified by a server of the present disclosure. The operating area 400 includes a plurality of travel zones. It will be understood that each of the virtual geofence areas comprise a unique set of operating restrictions, in some embodiments.

A first travel zone 402 indicates that a higher probability for damage to the nautical vehicle may occur based on a current position. These specialty areas include, for example, a marina. A second travel zone 404 indicates the nautical vehicle is in a no-wake zone. A third travel zone 406 indicates that the nautical vehicle is in a restricted area based on the position. A fourth travel zone 408 indicates that the nautical vehicle is in an open area based on the position. Each of these zones comprises attributes and the attributes are communicated to the boat operator through messages displayed on the device. These attributes can include speed limits, wake, beach proximity, collision probabilities, and so forth.

In some embodiments, a virtual geofence area that corresponds to the current travel zone in which the boat is operating is transmitted to the mobile device and displayed thereon. According to some embodiments, this is accomplished using an application that is installed on the mobile device. In other embodiments, the travel zone information can be transmitted to the mobile device from the server using push notifications or other messaging services. In one embodiment, the virtual geofence areas are overlaid on a map, as illustrated in FIG. 4, allowing the boat operator to visually comprehend the area in which the boat is operating. A current position of the boat can be identified on the map as well.

In some embodiments, the application is configured to tag images obtained with the plurality of cameras with at least a portion of the journey data, in combination with a time stamp, as described above.

The application can also allow the user to activate triggers, such as a collision trigger. In one or more embodiments, images are obtained when a user selects a trigger on a graphical user interface provided by the application.

In other embodiments, the server and mobile device cooperate to sense a collision event (from sensor data) of the nautical vehicle using the velocity or acceleration of the nautical vehicle. Next, any number of images are obtained using the plurality of cameras upon sensing the collision event. In some embodiments, each of the plurality of images is tagged with any of the velocity or acceleration of the nautical vehicle, a time stamp, a wind speed, a wind direction, the location information, travel zone information, and combinations thereof. In addition to capturing images, the system can capture audio, video, text, and other input types either from the sensors on the boat and/or the mobile device.

In some embodiments, the application is configured to create a journey report that illustrates the position for the nautical vehicle during use, and transmit the same to the server. The server can then forward the reports to a boat operator, boat owner, and/or insurance carrier, or other third party, such as the other party involved in the collision event.

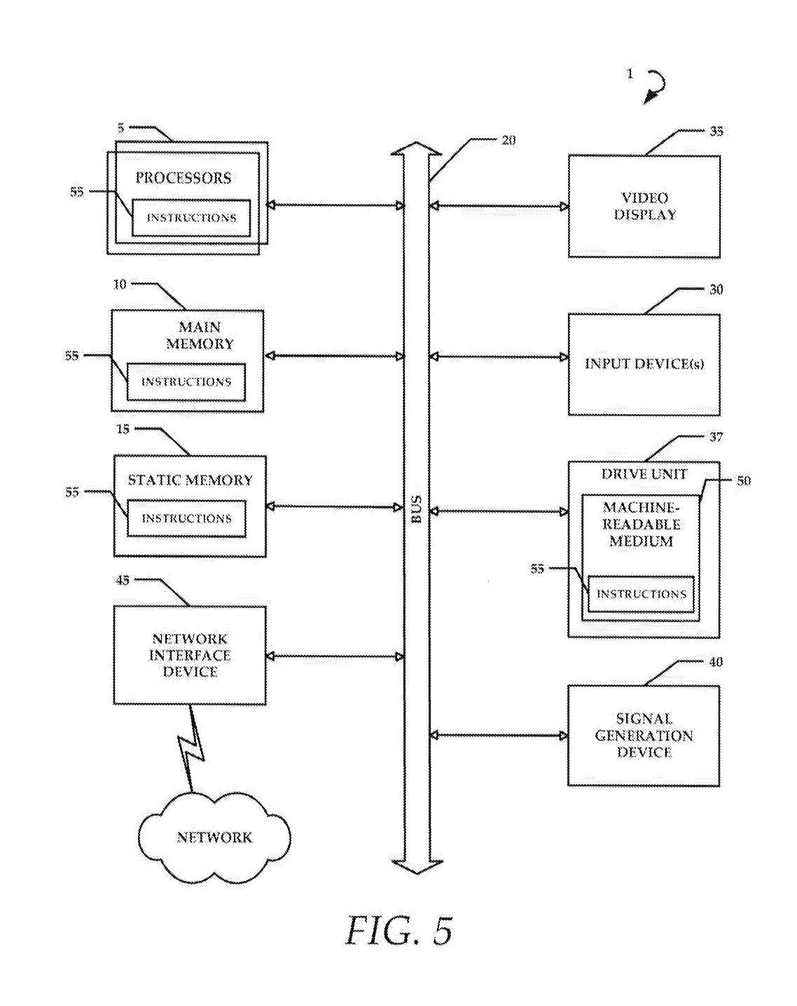

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine mfay operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 120) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system, comprising:
a server configured to store journey data; and
a plurality of sensors comprising:
a plurality of cameras that are configured to mount on a nautical vehicle;
a location sensor that locates a position of the nautical vehicle;
a sensor that measures velocity or acceleration of the nautical vehicle;
an environmental condition sensor that measures any of wind speed and direction, temperature, air pressure, and combinations thereof;
wherein the journey data comprises a collection of information obtained from the plurality of sensors; and
wherein the server is configured to transmit travel zone information to a mobile device located in proximity to the nautical vehicle based on the journey data.

2. The system according to claim 1, wherein the plurality of cameras comprise an aft sensor, a stern sensor, a port sensor, and a starboard sensor.

3. The system according to claim 1, further comprising an application stored on the mobile device, the application being executed to tag images obtained with the plurality of cameras with at least a portion of the journey data, in combination with a time stamp.

4. The system according to claim 3, wherein the images are obtained when a user selects a trigger on a graphical user interface provided by the application.

5. The system according to claim 4, wherein the mobile device receives the travel zone information and displays the same using the application.

6. The system according to claim 1, wherein the travel zone information includes a first travel zone that indicates that higher damage to the nautical vehicle may occur based on the position.

7. The system according to claim 1, wherein the travel zone information includes a second travel zone that indicates that the nautical vehicle is in a no-wake zone.

8. The system according to claim 1, wherein the travel zone information includes a third travel zone that indicates that the nautical vehicle is in a restricted area based on the position.

9. The system according to claim 1, wherein the travel zone information includes a fourth travel zone that indicates that the nautical vehicle is in an open area based on the position.

10. The system according to claim 1, wherein the mobile device is configured to create a final user report that indicates any violation of the travel zone information and transmit the same to the server.

11. The system according to claim 1, wherein the mobile device is configured to create a journey report that illustrates the position for the nautical vehicle during use, and transmit the same to the server.

12. The system according to claim 11, wherein the mobile device stores the journey data in a ring buffer prior to transmitting the same to the server.

13. A method, comprising:
receiving journey data from a plurality of sensors located on a nautical vehicle, wherein the journey data comprises:
images obtained from a plurality of cameras on the nautical vehicle;
location information of the nautical vehicle;
velocity or acceleration of the nautical vehicle;
environmental conditions that comprise any of wind speed and direction, temperature, air pressure, and combinations thereof; and
audio information obtained from a microphone on the nautical vehicle;
transmitting travel zone information to a mobile device, the travel zone information comprising information that is indicative of operating zones near the nautical vehicle; and
processing the journey data to create a journey report that illustrates or describes the journey data of the nautical vehicle obtained during use.

14. The method according to claim 13, further comprising receiving tagged versions of the images, wherein the tagged versions include the journey data obtained when the images were obtained, along with a time stamp for each image.

15. The method according to claim 13, wherein the tagged versions are received after the mobile device indicates an accident event has occurred.

16. The method according to claim 13, wherein the travel zone information includes:
a first travel zone that indicates that higher damage to the nautical vehicle may occur based on the location information;
a second travel zone that indicates that the nautical vehicle is in a no-wake zone;
a third travel zone that indicates that the nautical vehicle is in a restricted area based on the location information; and
a fourth travel zone that indicates that the nautical vehicle is in an open area based on the location information.

17. The method according to claim 13, further comprising transmitting an accident report to an insurance agency of an operator of the nautical vehicle.

18. The method according to claim 13, wherein the travel zone information includes virtual geofence areas that each comprise a unique set of operating restrictions.

19. The method according to claim 13, further comprising:
sensing a collision event of the nautical vehicle using the velocity or acceleration of the nautical vehicle;
obtaining a plurality of images using the plurality of cameras upon sensing the collision event; and
tagging the plurality of images with any of the velocity or acceleration of the nautical vehicle, a time stamp, a wind speed, a wind direction, the location information, travel zone information, and combinations thereof.
